(19) United States
(12) Patent Application Publication
(10) Pub. No.: US 2024/0155663 A1
(43) Pub. Date: May 9, 2024

(54) RADIO RESOURCE ALLOCATION METHOD AND RADIO RESOURCE ALLOCATION SYSTEM

(71) Applicant: INSTITUTE FOR INFORMATION INDUSTRY, TAIPEI CITY (TW)

(72) Inventors: CHENG-CHANG CHEN, TAIPEI CITY (TW); LI-SHENG CHEN, TAIPEI CITY (TW)

(21) Appl. No.: 17/990,625

(22) Filed: Nov. 18, 2022

(30) Foreign Application Priority Data
Nov. 3, 2022 (TW) 111141921

(51) Int. Cl. H04W 72/10; H04W 72/08

(52) U.S. Cl. CPC H04W 72/10; H04W 72/082; H04W 72/085

(57) ABSTRACT

A radio resource allocation method and a radio resource allocation system are provided. The radio resource allocation method includes: obtaining quality parameters of each of resource blocks, in which the quality parameters correspond to weight coefficients, respectively; adjusting the weight coefficients for a service requirement of each of network slices, and calculating, according to the weight coefficients and the quality parameters of each of the resource blocks, priority indices used to allocate the resource blocks to the network slices, respectively; and generating priority orders for allocating the resource blocks to the network slices, and configuring the base station to allocate the resource blocks to the network slices according to the priority orders.

### CROSS-REFERENCE TO RELATED PATENT APPLICATION

This application claims the benefit of priority to Taiwan Patent Application No. 111141921, filed on Nov. 3, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resource allocation method and a resource allocation method, and more particularly to a radio resource allocation method and a radio resource allocation system that facilitate a base station in allocating appropriate resource blocks to network slices that meet different service requirements.

### BACKGROUND OF THE DISCLOSURE

In new generation of mobile communication technology, network slicing is introduced to enable multiple network slices to meet certain service requirements. That is, each network slice can be utilized for a service type or an application context. For example, network slices of the fifth-generation mobile communication are customized to the various applications, including enhanced mobile broadband (eMBB), ultra-reliable and low latency communications (uRLLC), and massive machine-type communications (mMTC).

Furthermore, the eMBB is used to meet service requirements of high bandwidth, the high speed and high capacity, the uRLLC is used to meet service requirements of high reliability and low time delay, and the mMTC is used to meet service requirements of the Internet of Things (IoTs). Therefore, the base station needs to be able to allocate appropriate resource blocks to network slices that meet different service requirements. However, inappropriate allocations for the resource blocks may lead to high transmission error rate or a waste of valuable radio resources.

### SUMMARY OF THE DISCLOSURE

In response to the above-referenced technical inadequacies, the present disclosure provides a radio resource allocation method and a radio resource allocation system that facilitate a base station in allocating appropriate resource blocks to network slices that meet different service requirements.

In one aspect, the present disclosure provides a radio resource allocation method, which is applicable to a radio resource allocation system that includes a base station and a processing device. The base station is configured to allocate a plurality of resource blocks to a plurality of network slices. The radio resource allocation method is executed by the processing device and includes the following steps: obtaining a plurality of quality parameters of each of the plurality of resource blocks, in which the plurality of quality parameters correspond to a plurality of weight coefficients, respectively; adjusting the plurality of weight coefficients for a service requirement of each of the plurality of network slices, and calculating, according to the plurality of weight coefficients and the quality parameters of each of the plurality of resource blocks, a plurality of priority indices used to allocate the plurality of resource blocks to the plurality of network slices, respectively; and generating, according to the plurality of priority indices, a plurality of priority orders for allocating the plurality of resource blocks to the plurality of network slices, and configuring the base station to allocate the plurality of resource blocks to the plurality of network slices according to the plurality of priority orders.

In another aspect, the present disclosure provides a radio resource allocation system, which includes a base station and a processing device. The base station is configured to allocate a plurality of resource blocks to a plurality of network slices. The processing device is coupled to the base station, and is configured to execute the following steps: obtaining a plurality of quality parameters of each of the plurality of resource blocks, in which the plurality of quality parameters correspond to a plurality of weight coefficients, respectively; adjusting the plurality of weight coefficients for a service requirement of each of the plurality of network slices, and calculating, according to the plurality of weight coefficients and the quality parameters of each of the plurality of resource blocks, a plurality of priority indices used to allocate the plurality of resource blocks to the plurality of network slices, respectively; and generating, according to the plurality of priority indices, a plurality of priority orders for allocating the plurality of resource blocks to the plurality of network slices, and configuring the base station to allocate the plurality of resource blocks to the plurality of network slices according to the plurality of priority orders.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a radio resource allocation system according to one embodiment of the present disclosure;

FIG. 2 is a flowchart of a radio resource allocation method according to a first embodiment of the present disclosure;

FIG. 3 is a schematic diagram of resource blocks according to one embodiment of the present disclosure;

FIG. 4 is a schematic diagram showing priority indices used to allocate resource blocks to network slices according to the first embodiment of the present disclosure;

FIG. 5 is a schematic diagram showing priority orders for allocating the resource blocks to the network slices according to the first embodiment of the present disclosure;

FIG. 6 is a flowchart of a radio resource allocation method according to a second embodiment of the present disclosure;

FIG. 7 is a schematic diagram showing priority indices used to allocate resource blocks to network slices according to the second embodiment of the present disclosure; and

FIG. 8 is a schematic diagram of adjusted priority indices of target resource blocks according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

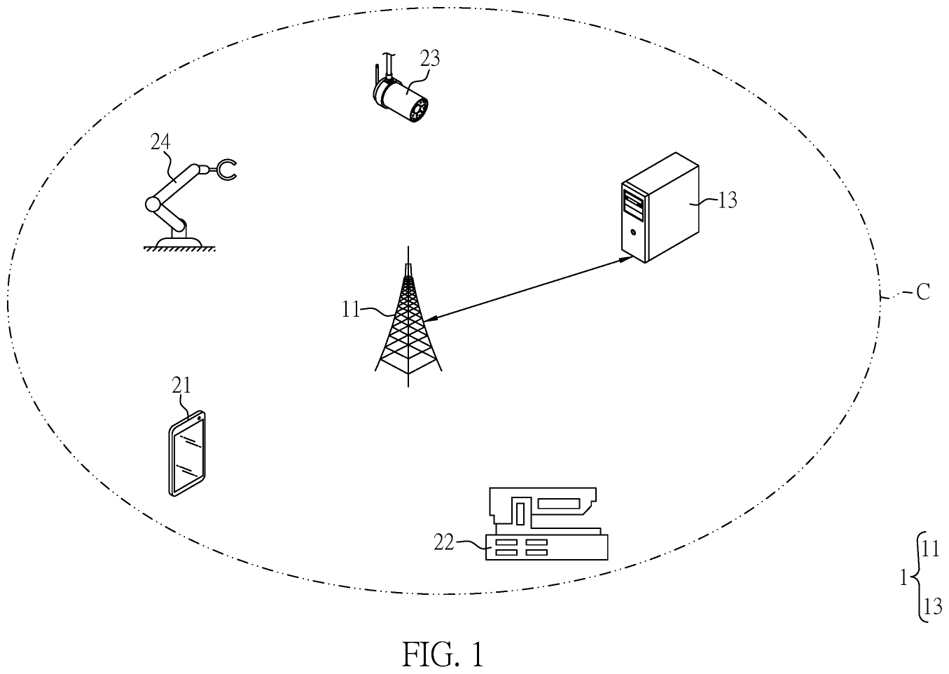

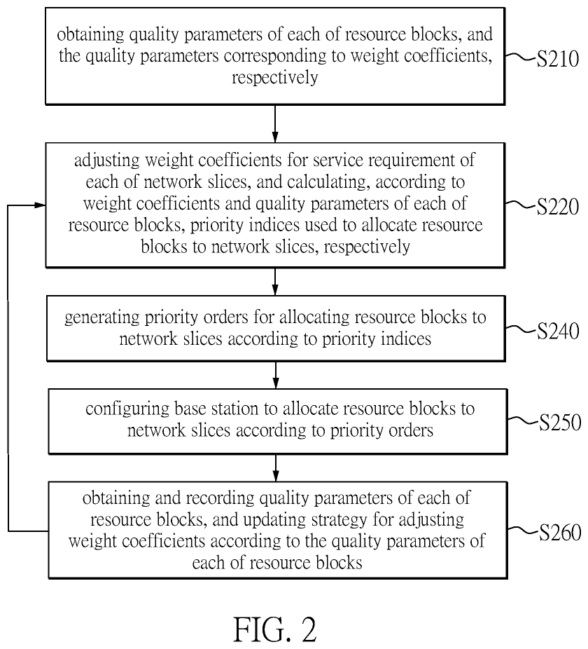

Reference is made to FIGS. 1 and 2, FIG. 1 is a schematic diagram of a radio resource allocation system 1 according to one embodiment of the present disclosure, and FIG. 2 is a flowchart of a radio resource allocation method according to a first embodiment of the present disclosure. As shown in FIG. 1, the radio resource allocation system 1 includes a base station 11 and a processing device 13. The base station 11 is configured to allocate a plurality of resource blocks to a plurality of network slices.

Specifically, a plurality of user devices corresponding to multiple network slices (i.e., multiple service types) can be located in a signal coverage range C of the base station 11. However, the present disclosure does not limit the number of network slices within the signal coverage range C and the number of the user devices of each network slice. For the convenience of the following description, the present embodiment merely takes four user devices 21 to 24 (i.e., user devices 21, 22, 23 and 24) corresponding to four network slices (i.e., four service types) within the signal coverage range C as an example. Therefore, the base station 11 can be configured to allocate a plurality of resource blocks to the four network slices corresponding to the user devices 21 to 24.

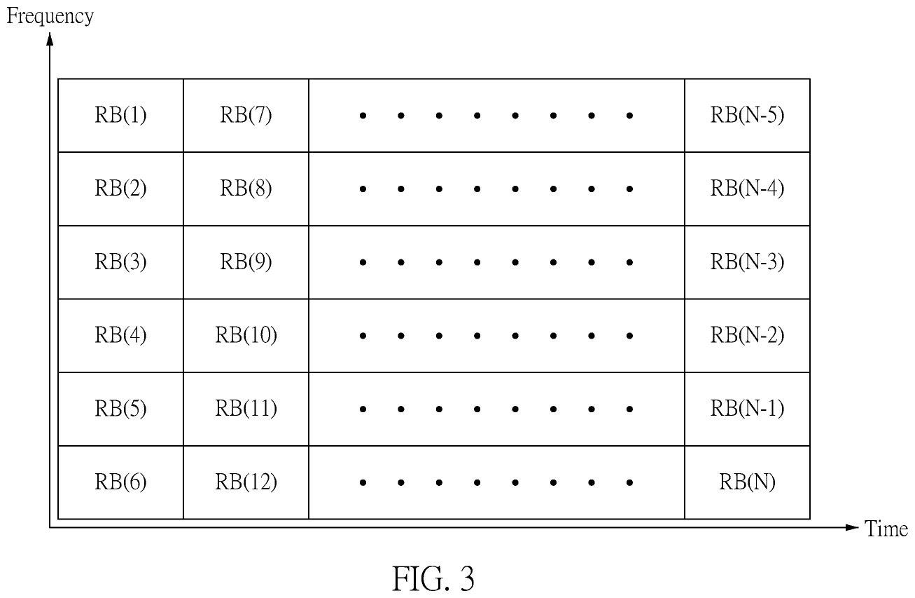

Reference is made to FIG. 3, which is a schematic diagram of resource blocks according to one embodiment of the present disclosure. As shown in FIG. 3, frames of the new generation mobile communication system (e.g., the fifth-generation (5G) mobile communication technology) can be divided into a plurality of resource blocks RB(1) to RB(N) in the time domain and the frequency domain, where N is an integer greater than 1, and radio resource allocated by the base station 11 to one user device uses one resource block as the minimum unit. However, each resource block has different transmission capabilities in response to different time intervals or frequency bands. Therefore, inappropriate allocation for the resource blocks RB(1) to RB(N) leads to high transmission error rate or a waste of valuable radio resources.

In order to solve the above-mentioned issues, the processing device 13 of the radio resource allocation system 1 is coupled to the base station 11 and is configured to execute steps of FIG. 2. The processing device 13 can be a specific machine or device such as a self-organizing networks (SON) server, a radio intelligent controller (RIC) or a processor of the base station 11, but the present disclosure is not limited thereto.

In other words, the radio resource allocation method in this embodiment is applicable to the radio resource allocation system 1, and is executed by the processing device 13, but the present disclosure does not limit the specific implementation of the processing device 13. As shown in FIG. 2, in step S210, the processing device 13 obtains a plurality of quality parameters of each of the plurality of resource blocks, and the plurality of quality parameters correspond to a plurality of weight coefficients, respectively. Next, in step S220, the processing device 13 adjusts the weight coefficients for a service requirement of each of the network slices, and calculates, according to (e.g., by using) the weight coefficients and the quality parameters of each of the resource blocks, a plurality of priority indices used to allocate the plurality of resource blocks to the plurality of network slices, respectively.

Next, in step S240, the processing device 13 generates a plurality of priority orders for allocating the plurality of resource blocks RB(1) to RB(N) to the network slices according to the priority indices, and in step S250, the processing device 13 configures the base station 11 to allocate the resource blocks RB(1) to RB(N) to the network slices according to the priority orders. That is, in this embodiment, the base station 11 can be configured to allocate the resource blocks RB(1) to RB(N) to the four network slices corresponding to the user devices 21-24 according to the priority orders generated by the processing device 13.

In this embodiment, each of the resource blocks can be pre-allocated to one terminal equipment for data transmission with the base station 11. It should be noted that the terminal equipment may be one of the user devices 21 to 24 or other user device, and the quality parameters of each of the resource blocks include a reference signal received power (RSRP), an error rate and an interference indicator. The error rate is one or a combination of a bit error rate (BER), a packet error rate (BER) and block error rate (BLER), but the present disclosure is not limited thereto.

Specifically, in step S210, the processing device 13 can obtain an RSRP for each of the plurality of resource blocks that is pre-allocated to the terminal equipment for data transmission with the base station 11, and uses the obtained RSRP to serve as the RSRP of each of the resource blocks. The processing device 13 can also obtain an error rate (e.g., the BER, PER or BLER) for each of the resource blocks that is pre-allocated to the terminal equipment for data transmission with the base station 11, and uses the obtained error rate to serve as the error rate of each of the resource blocks. In addition, in step S210, the processing device 13 can also obtain a received signal strength indication (RSSI) for each of the resource blocks that is pre-allocated to the terminal equipment for data transmission with the base station 11, and use the obtained RSSI to serve as an RSSI of each of the resource blocks.

In this embodiment, the aforementioned RSRP, error rate and RSSI can be measured by the terminal equipment and then returned to the base station 11, and the processing device 13 obtains the aforementioned RSRP, error rate and RSSI through the base station 11, but the present disclosure is not limited thereto. In other embodiments, the aforementioned RSRP, error rate and RSSI can also be measured by the terminal equipment and then directly transmitted to the processing device 13, but the present disclosure is not limited thereto. In addition, in practice, the terminal equipment can measure the aforementioned RSRP, error rate, and RSSI through multiple measurement devices (e.g., an RSRP measurement device, a BER measurement device, and an RSSI measurement device).

On the other hand, the quality parameters of each resource block also include a jitter value and a quantity of supportable network slices. Therefore, in step S210, the processing device 13 can further obtain a jitter value for each of the plurality of resource blocks that is pre-allocated to the terminal equipment for data transmission with the base station 11, and can use the obtained jitter value to serve as the jitter value of each of the resource blocks, and obtain the quantity of the supportable network slices of each of the resources through the base station 11. Similarly, the aforementioned jitter value can also be measured by the terminal equipment and then returned to the base station 11, and the processing device 13 obtains the aforementioned jitter value through the base station 11, but the present disclosure is not limited thereto. In addition, in practice, the terminal equipment can measure the aforementioned jitter value through a bit error analyzer or an oscilloscope.

In this embodiment, the priority indices used to allocate the resource blocks, respectively, to the network slices can be represented by the following equation:

$${ε}_{k} ( i ) = α \cdot {P}_{r s r p} ( i ) + β \cdot \frac{1}{E R ( i )} + γ \cdot \frac{1}{{P}_{inter} ( i )} + δ \cdot \frac{1}{N ( i )} + θ \cdot \frac{1}{T ( i )} ;$$

where εₖ(i) is the priority index used to allocate an i-th resource block RB(i) in the resource blocks RB(1) to RB(N) to a k-th network slice. i is a positive integer less than or equal to N, that is, i is a positive integer less than or equal to the total number of the resource blocks, and k is a positive integer less than or equal to the total number of the network slices. Pᵣₛᵣₚ(i) is the RSRP of the i-th resource block RB(i), ER(i) is the error rate of the i-th resource block RB(i), Pᵢₙₜₑᵣ(i) is the interference indicator of the i-th resource block RB(i), N(i) is the quantity of the supportable network slices of the i-th resource block RB(i), and T(i) is the jitter value of the i-th resource block RB(i).

α, β, γ, δ and θ are the weight coefficients corresponding to the RSRP, the error rate, the interference index, the quantity of the supportable network slices and the jitter value, respectively, and α, β, γ, δ and θ represent importance of Pᵣₛᵣₚ(i), 1/ER(i), 1/Pᵢₙₜₑᵣ(i), 1/N(i) and 1/T(i) in εₖ(i). It can be seen that the higher εₖ(i) is, the more suitable the i-th resource block RB(i) is to be allocated to the k-th network slice. In this embodiment, a sum of α, β, γ, δ and θ can be a constant value, for example, the sum equals to 1.

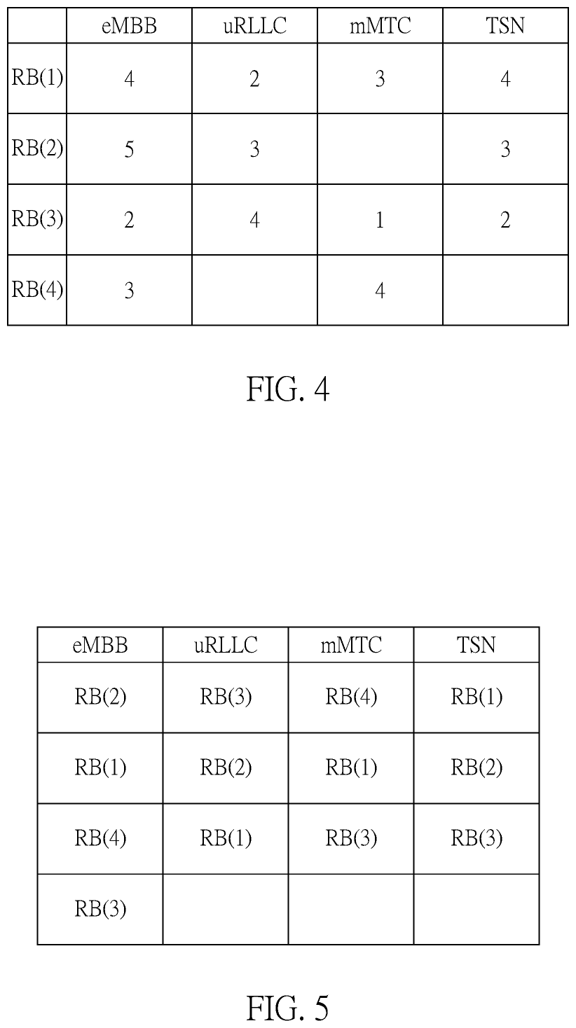

Reference is made to FIGS. 4 and 5, FIG. 4 is a schematic diagram showing priority indices used to allocate resource blocks to network slices according to the first embodiment of the present disclosure, and FIG. 5 is a schematic diagram showing priority orders for allocating the resource blocks to the network slices according to the first embodiment of the present disclosure. For the convenience of the following description, the resource blocks RB(1) to RB(N) in this embodiment merely take four resource blocks (i.e., N equals 4) as an example. Furthermore, for clearly comparing the priority indices used to allocate the resource blocks to the network slices, respectively, the processing device 13 can further normalize the priority indices used to allocate the resource blocks respectively to the network slices to integers between 1 and 10, but the present disclosure is not limited thereto.

Specifically, the four network slices corresponding to the user devices 21 to 24 being the eMBB, uRLLC, mMTC, and time-sensitive networking (TSN) are taken as examples, but the present disclosure is not limited thereto. Therefore, when adjusting the weight coefficient for service requirements (e.g., high bandwidth and high capacity) of the eMBB (i.e., the first network slice in this embodiment), since the RSRP and the interference indicator are strongly correlated to the service requirements such as the high bandwidth and the high capacity, the processing device 13 can adjust α and γ to be higher, and adjust β, δ and θ to be lower, such that εₖG(i) can reflect characteristics such as the bandwidth and the capacity to a greater extent. Next, according to the adjusted weight coefficient (e.g., α=γ=0.35, and β=δ=θ=0.1) and the adjusted quality parameters of each of the resource blocks, the processing device 13 can calculate the priority indices used to allocate the resource blocks to the eMBB according to the above equation.

As shown in FIG. 4, the priority index ε₁(1) used to allocate the resource block RB(1) to the eMBB is 4, and the priority index ε₁(2) used to allocate the resource block RB(2) to the eMBB is 5. In addition, the priority index ε₁(3) of the resource block RB(3) allocated to the eMBB is 2, and the priority index ε₁(4) of the resource block RB(4) to the eMBB is 3. It can be seen from the above that the higher ε₁(i) indicates that the i-th resource block RB(i) is more suitable for being allocated to eMBB. Therefore, as shown in FIG. 5, according to the priority indices used to allocate the resource blocks to the eMBB, the processing device 13 can further generate a priority order for allocating the resource blocks RB(1) to RB(4) to the eMBB, that is, in an order of the resource block RB(2), the resource block RB(1), the resource block RB(4), and the resource block RB(3). That is, the step of generating the priority orders includes: sorting the priority indices used to allocate the resource blocks RB(1) to RB(4) to each of the network slices from high to low, so as to generate each of the priority orders.

On the other hand, when adjusting the weight coefficient for service requirements (e.g., high reliability) of the uRLLC (i.e., the second network slice in this embodiment), since the error rate and the quantity of the supportable network slices are strongly correlated to the high reliability, the processing device 13 can adjust β and δ to be higher, and adjust α, γ and θ to be lower, such that εₖ (i) can reflect reliability to a greater extent. Next, according to the adjusted weight coefficient (e.g., β=δ=0.35, and α=γ=θ=0.1) and the adjusted quality parameters of each of the resource blocks, the processing device 13 can calculate the priority indices used to allocate the resource blocks to the uRLLC according to the above equation.

In addition, according to the service requirements of the mMTC, the processing device 13 can adjust γ to be higher, and adjust α, β, δ and θ to be lower. According to the service requirements of the TSN, the processing device 13 can adjust β and θ to be higher, and adjust α, γ and δ to be lower. In other embodiments, for the service requirements of other network slices, such as extended reality (XR) or virtual reality (VR), the processing device 13 can adjust α to be higher, and adjust β, γ, δ and θ to be lower. Alternatively, for the service requirements of unmanned aerial vehicle (UAV), the processing device 13 can adjust θ to be higher and adjust α, γ and δ to be lower, but the present disclosure is not limited thereto.

It should be noted that, according to the specifications of the new generation mobile communication technology, certain resource blocks may have been preset for specific purposes due to corresponding time interval or frequency band, or may be prohibited from being allocated to user devices of certain network slices. Therefore, in step S210, in addition to obtaining the quantity of supportable network slices of each of the resource blocks, the processing device 13 can also determine whether or not the i-th resource block RB(i) cannot be allocated to the k-th network slice according to the time interval or frequency band corresponding to the i-th resource block RB(i). In addition, in response to determining that the i-th resource block RB(i) cannot be allocated to the k-th network slice, the calculation of the priority index used to allocate the i-th resource block RB(i) to the k-th network slice performed by the processing device 13 through the above equation can be omitted, but the processing device 13 can directly set the priority index used to allocate the i-th resource block RB(i) to the k-th network slice as a null value.

As shown in FIG. 4, the priority index ε₂(1) used to allocate the resource block RB(1) to the uRLLC is 2, the priority index ε₂(2) used to allocate the resource block RB(2) to the uRLLC is 3, and the priority index ε₂(3) used to allocate the resource block RB(3) to the uRLLC is 4. In addition, in response to determining that the resource block RB(4) cannot be allocated to the uRLLC according to the time interval or frequency band corresponding to the resource block RB(4), the processing device 13 can directly set the priority index ε₂ (4) used to allocate the resource block RB(4) to the uRLLC as a null value. Similarly, the higher ε₂(i) indicates that the i-th resource block RB(i) is more suitable for being allocated to the uRLLC. Therefore, as shown in FIG. 5, according to the priority indices used to allocate the resource blocks to the uRLLC, the processing device 13 can further generate a priority order for allocating the resource blocks RB(1) to RB(4) to the uRLLC, that is, in an order of the resource block RB(3), the resource block RB(2), and the resource block RB(1).

However, details associated with the processing device 13 adjusting the weight coefficients according to the service requirements of the mMTC or TSN (i.e., the third or fourth network slice in this embodiment), calculating the priority indices used to allocate the resource blocks to the mMTC or the TSN, and then generating the priority order for allocating the resource blocks RB(1) to RB(4) to the mMTC or TSN are similar to the details mentioned above, and thus the repetitive descriptions are omitted hereinafter. Next, the processing device 13 can configure the base station 11 to allocate the resource blocks RB(1) to RB(4) to the eMBB, uRLLC, mMTC and TSN, respectively, according to the four priority orders of FIG. 5.

In this embodiment, the base station 11 can be configured by the processing device 13 to allocate the resource block RB(2) to the user device 21 of the eMBB, allocate the resource block RB(3) to the user device 22 of the uRLLC, allocate the resource block RB(4) to the user device 23 of the mMTC, and allocate the resource block RB(1) to the user device 24 of the TSN according to the four priority orders in FIG. 5.

Since transmission quality of each resource block may be changed by other factors, after the base station 11 and the user devices 21-24 perform data transmission according to the allocated resource blocks, the radio resource allocation method of this embodiment can further include step S260. In step S260, the processing device 13 can continue to obtain and record (new) quality parameters of each of the resource blocks, and update a strategy for adjusting the weight coefficients according to the (new) quality parameters of each of the resource blocks. For example, the original strategy of increasing α and γ to be 0.35 and decreasing β, δ and θ to be 0.1 for the service requirements of the eMBB can be updated to a new strategy of increasing α and γ to be 0.38 and decreasing β, δ and θ to be 0.08, but the present disclosure is not limited thereto.

Finally, after step S260, the radio resource allocation method of this embodiment can proceed back to step S220. It should be noted that, in step S260, taking to-be-obtained (new) quality parameters being the quality parameters of the resource block RB(2) as an example, the processing device 13 can obtain the RSRP of data transmission performed between the base station 11 and the user device 21 in response to the resource block RB(2) being allocated to the user device 21, and use the obtained RSRP to serve as an (new) RSRP of the resource block RB(2). The processing device 13 can further obtain the error rate (e.g., BER, PER or BLER) of data transmission performed between the user device 21 and the base station 11 in response to the resource block RB(2) being allocated to the user device 21, and use the obtained error rate as a (new) error rate of the resource block RB(2).

In addition, the processing device 13 can also obtain a RSSI of the data transmission performed between the user device 21 and the base station 11 in response to the resource block RB(2) being allocated to the user device 21, use the obtained RSSI as a (new) RSSI of the resource block RB(2), and use the (new) RSSI of resource block RB(2) to be divided by the (new) RSRP of the resource block RB(2) to obtain an (new) interference indicator of the resource block RB(2). Similarly, the aforementioned RSRP, error rate, and RSSI can all be measured by the user device 21 and then returned to the base station 11, and the processing device 13 obtains the aforementioned RSRP, error rate, and RSSI through the base station 11, but the present disclosure is not limited thereto. In addition, the processing device 13 can also obtain a jitter value of the data transmission performed between the user device 21 and the base station 11 in response to the resource block RB(2) being allocated to the user device 21, and use the obtained jitter value as a (new) jitter value of the resource block RB(2). Since the subsequent details are similar to the previous ones, the repetitive descriptions will be omitted hereinafter.

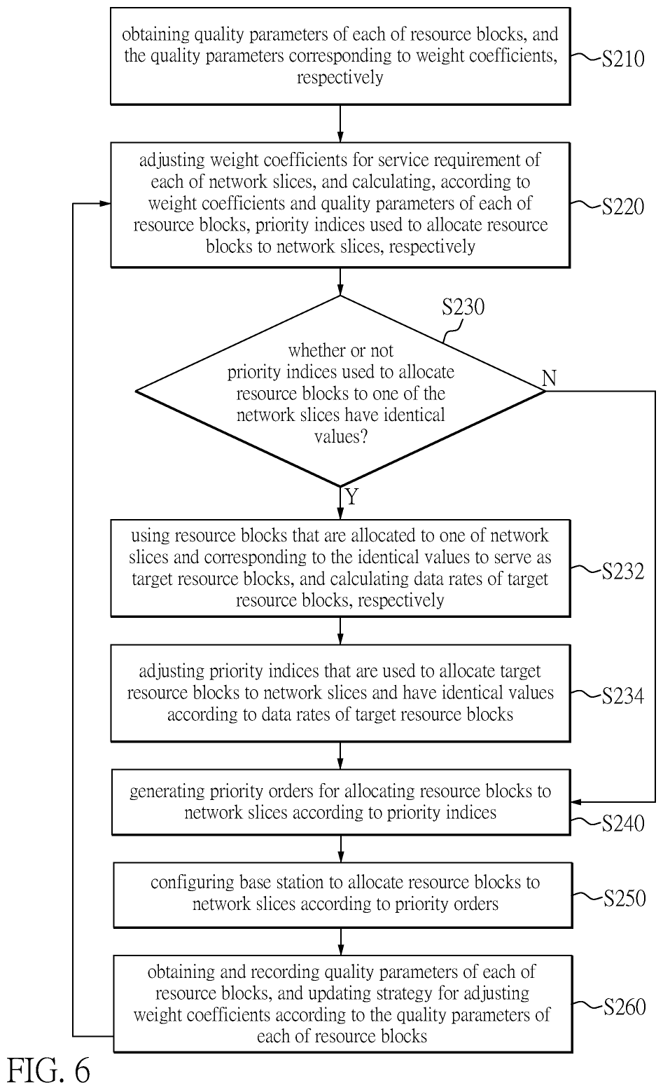

On the other hand, reference can be made to FIG. 6, which is a flowchart of a radio resource allocation method according to a second embodiment of the present disclosure, and similarities between FIG. 6 and FIG. 2 will not be repeated hereinafter. As shown in FIG. 6, before the processing device 13 generates the priority orders, the radio resource allocation method of this embodiment can further include steps S230, S232 and S234. In step S230, the processing device 13 determines whether or not the priority indices used to allocate the plurality of resource blocks to one of the network slices have identical values. If the determination is negative (e.g., “N” as shown in FIG. 6), the radio resource allocation method of this embodiment proceeds directly to step S240. If the determination is affirmative (e.g., “Y” as shown in FIG. 6), the radio resource allocation method of this embodiment proceeds to step S232, and proceeds to step 234 after step S232 is performed. In addition, the radio resource allocation method of this embodiment proceeds step S240 after step S234 is performed.

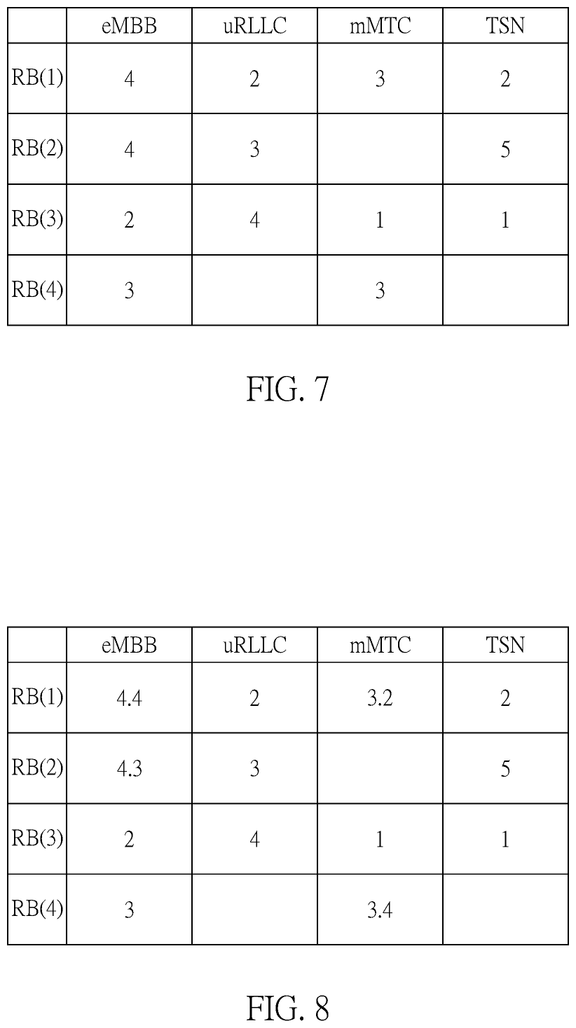

In step S232, in response to determining that the priority indices used to allocate the resource blocks RB(1) to RB(4) to the one of the network slices have the identical values, the processing device 13 uses the resource blocks that are allocated to the one of the network slices and corresponding to the identical values to serve as target resource blocks, and calculates data rates of the target resource blocks, respectively. In addition, in step S234, the processing device 13 adjusts the priority indices that are used to allocate the target resource blocks to the network slices and have the identical values according to the data rates of the target resource blocks. Reference is made to FIGS. 7 and 8, FIG. 7 is a schematic diagram showing priority indices used to allocate resource blocks to network slices according to the second embodiment of the present disclosure, and FIG. 8 is a schematic diagram of adjusted priority indices of target resource blocks according to the second embodiment of the present disclosure.

Specifically, the processing device 13 can first determine whether or not the priority indices ε₁(1), ε₁(2), ε₁(3), and ε₁(4) used to allocate the resource blocks RB(1) to RB(4) to the eMBB have identical values, and then determine whether or not the priority indices ε₂(1), ε₂(2), ε₂(3), and ε₂(4) used to allocate the resource blocks RB(1) to RB(4) to the uRLLC have identical values, and so forth, the processing device 13 can also determine whether or not the priority indices ε₁(1), ε₁(2), ε₁(3), and ε₁(4) used to allocate the resource blocks RB(1) to RB(4) to the TSN have identical values.

As shown in FIG. 7, since the priority indices ε₁(1) and ε₁(2) used to allocate the resource block RB(1) and the resource block RB(2) to the eMBB have identical values, and the priority indices ε₃(1) and ε₃(3) used to allocate the resource block RB(1) and the resource block RB(3) to the mMTC also have identical values, the processing device 13 can execute steps S232 and S234 to adjust the priority indices ε₁(1) and ε₁(2) used to allocate the resource block RB(1) and the resource block RB(2) to the eMBB index, and also adjust the priority indices ε₃(1) and ε₃(3) used to allocate the resource block RB(1) and the resource block RB(3) allocated to the mMTC. That is, the target resource blocks in this embodiment can be the resource block RB(1), the resource block RB(2), and the resource block RB(3).

Further, in step S232, the processing device 13 can calculate the data rate of each of the target resource blocks according to the RSRP and the RSSI of each of the target resource blocks. In addition, the priority orders for allocating the target resource blocks to the network slices having the identical values in the corresponding priority indices can be sorted according to the data rate from high to low. For example, for the resource block RB(1) and the resource block RB(2) that are allocated to the eMBB and corresponding to the priority indices ε₁(1) and ε₁(2) having the identical values, the processing device 13 can calculate the data rate of the resource block RB(1) to be 32.4 Mbps according to the RSRP and the RSSI of the resource block RB(1), and calculate the data rate of the resource block RB(2) to be 25.6 Mbps according to the RSRP and the RSSI of resource block RB(2).

Next, since the resource block RB(1) has the data rate higher than that of the resource block RB(2), the processing device 13 can adjust the priority index ε₁(1) used to allocate the resource block RB(1) to the eMBB to be higher than the priority index ε₁(2) used to allocate the resource block RB(2) to the eMBB, such that the resource block RB(1) ranks higher than the resource block RB(2) in the priority order for allocating the resource blocks to the eMBB. As shown in FIG. 8, the processing device 13 can adjust the priority index ε₁(1) used to allocate the resource block RB(1) to the eMBB to be 4.4, and adjust the priority index ε₁(2) used to allocate the resource block RB(2) to the eMBB to be 4.3, but the present disclosure is not limited thereto.

On the other hand, for the resource block RB(1) and the resource block RB(2) that are allocated to the mMTC and corresponding to the priority indices ε₃(1) and ε₃(3) having the identical values, the processing device 13 can calculate the data rate of the resource block RB(1) to be 32.4 Mbps according to the RSRP and the RSSI of the resource block RB(1), and calculate the data rate of the resource block RB(3) to be 33 Mbps according to the RSRP and the RSSI of resource block RB(3).

Next, since the resource block RB(3) has the data rate higher than that of the resource block RB(1), the processing device 13 can adjust the priority index ε₃(3) used to allocate the resource block RB(3) to the mMTC to be higher than the priority index ε₃(1) used to allocate the resource block RB(1) to the mMTC, such that the resource block RB(3) ranks higher than the resource block RB(1) in the priority order for allocating the resource blocks to the mMTC. As shown in FIG. 8, the processing device 13 can adjust the priority index ε₃(3) used to allocate the resource block RB(1) to the mMTC to be 3.4, and adjust the priority index ε₃(1) used to allocate the resource block RB(1) to the mMTC to be 3.3, but the present disclosure is not limited thereto. Since the subsequent details are similar to the previous embodiments, the repetitive descriptions will be omitted hereinafter.

In conclusion, in the radio resource allocation method and the radio resource allocation system provided by the present disclosure, the weight coefficients can be adjusted for the service requirements of each of the network slices, and according to the adjusted weight coefficients and the quality parameters of each of the resource blocks, the priority indices used to allocate the resource blocks to the network slices can be calculated, respectively, and the priority orders for allocating the resource blocks to the network slices can be generated, such that the base station can allocate appropriate resource blocks for the network slices that meet different service requirements. In this way, in the present disclosure, the error rate in data transmission can be reduced, and the resource utilization rate and the data rate can be increased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A radio resource allocation method, applicable to a radio resource allocation system comprising a base station and a processing device, the base station being configured to allocate a plurality of resource blocks to a plurality of network slices, and the radio resource allocation method being executed by the processing device and comprising the following steps:
obtaining a plurality of quality parameters of each of the plurality of resource blocks, wherein the plurality of quality parameters correspond to a plurality of weight coefficients, respectively;
adjusting the plurality of weight coefficients for a service requirement of each of the plurality of network slices, and calculating, according to the plurality of weight coefficients and the quality parameters of each of the plurality of resource blocks, a plurality of priority indices used to allocate the plurality of resource blocks to the plurality of network slices, respectively; and
generating, according to the plurality of priority indices, a plurality of priority orders for allocating the plurality of resource blocks to the plurality of network slices, and configuring the base station to allocate the plurality of resource blocks to the plurality of network slices according to the plurality of priority orders.

2. The radio resource allocation method according to claim 1, wherein the quality parameters of each of the plurality of resource blocks include a reference signal received power (RSRP), an error rate and an interference indicator, and the error rate is one or a combination of a bit error rate, a packet error rate and a block error rate.

3. The radio resource allocation method according to claim 2, wherein the step of obtaining a plurality of quality parameters of each of the plurality of resource blocks further comprises:
obtaining the RSRP for each of the plurality of resource blocks that is pre-allocated to a terminal equipment for data transmission with the base station, and using the obtained RSRP to serve as the RSRP of each of the resource blocks;
obtaining an error rate for each of the plurality of resource blocks that is pre-allocated to the terminal equipment for data transmission with the base station, and using the obtained error rate to serve as the error rate of each of the resource blocks;
obtaining a received signal strength indication (RSSI) for each of the plurality of resource blocks that is pre-allocated to the terminal equipment for data transmission with the base station, and using the obtained RSSI to serve as an RSSI of each of the plurality of resource blocks; and
dividing the RSSI of each of the resource blocks by the RSRP of each of the resource blocks to obtain the interference indicator of each of the resource blocks.

4. The radio resource allocation method according to claim 2, wherein the plurality of quality parameters of each of the resource blocks further include a jitter value and a quantity of supportable network slices.

5. The radio resource allocation method according to claim 4, wherein the step of obtaining a plurality of quality parameters of each of the plurality of resource blocks further comprises:
obtaining a jitter value for each of the plurality of resource blocks that is pre-allocated to a terminal equipment for data transmission with the base station, using the obtained jitter value to serve as the jitter value of each of the resource blocks, and obtaining the quantity of the supportable network slices of each of the resources through the base station.

6. The radio resource allocation method according to claim 4, wherein the plurality of priority indices used to allocate the plurality of resource blocks respectively to the plurality of network slices are represented by a following equation:
$${ε}_{k} ( i ) = α \cdot {P}_{r s r p} ( i ) + β \cdot \frac{1}{E R ( i )} + γ \cdot \frac{1}{{P}_{inter} ( i )} + δ \cdot \frac{1}{N ( i )} + θ \cdot \frac{1}{T ( i )} ;$$
where εₖ (i) is the priority index used to allocate an i-th resource block in the plurality of resource blocks to a k-th network slice of the plurality of network slices, i is a positive integer less than or equal to a total number of the plurality of resource blocks, k is a positive integer less than or equal to a total number of the plurality of network slices, Pᵣₛᵣₚ(i) is the RSRP of the i-th resource block, ER(i) is the error rate of the i-th resource block, Pᵢₙₜₑᵣ(i) is the interference indicator of the i-th resource block, N(i) is the quantity of the supportable network slices of the i-th resource block, T(i) is the jitter value of the i-th resource block, and α, β, γ, δ and θ are the weight coefficients corresponding to the RSRP, the error rate, the interference index, the quantity of the supportable network slices and the jitter value, respectively.

7. The radio resource allocation method according to claim 6, wherein the step of generating the plurality of priority orders further comprises:
sorting the priority indices used to allocate the plurality of resource blocks to each of the plurality of network slices from high to low, so as to generate the plurality of priority orders.

8. The radio resource allocation method according to claim 7, further comprising configuring the processing device to execute the following steps before generating the plurality of priority orders:
determining whether or not the priority indices used to allocate the plurality of resource blocks to one of the network slices have identical values;
in response to determining that the priority indices used to allocate the plurality of resource blocks to one of the network slices have the identical values, using the resource blocks that are allocated to the one of the network slices and corresponding the identical values to serve as target resource blocks, and calculating the data rates of the target resource blocks, respectively; and
according to the data rates of the target resource blocks, adjusting the priority indices that are used to allocate the target resource blocks to the network slices and have the identical values.

9. A radio resource allocation system, comprising:
a base station configured to allocate a plurality of resource blocks to a plurality of network slices; and
a processing device coupled to the base station, wherein the processing device is configured to execute the following steps:
obtaining a plurality of quality parameters of each of the plurality of resource blocks, wherein the plurality of quality parameters correspond to a plurality of weight coefficients, respectively;
adjusting the plurality of weight coefficients for a service requirement of each of the plurality of network slices, and calculating, according to the plurality of weight coefficients and the quality parameters of each of the plurality of resource blocks, a plurality of priority indices used to allocate the plurality of resource blocks to the plurality of network slices, respectively; and
generating, according to the plurality of priority indices, a plurality of priority orders for allocating the plurality of resource blocks to the plurality of network slices, and configuring the base station to allocate the plurality of resource blocks to the plurality of network slices according to the plurality of priority orders.

10. The radio resource allocation system according to claim 9, wherein the quality parameters of each of the plurality of resource blocks comprise a reference signal received power (RSRP), an error rate and an interference indicator, and the error rate is one or a combination of a bit error rate, a packet error rate and a block error rate.

11. The radio resource allocation system according to claim 10, wherein the step of obtaining a plurality of quality parameters of each of the plurality of resource blocks further comprises:
obtaining the RSRP for each of the plurality of resource blocks that is pre-allocated to a terminal equipment for data transmission with the base station, and using the obtained RSRP to serve as the RSRP of each of the resource blocks;
obtaining a bit error rate for each of the plurality of resource blocks that is pre-allocated to the terminal equipment for data transmission with the base station, and using the obtained bit error rate to serve as the error rate of each of the resource blocks;
obtaining a received signal strength indication (RSSI) for each of the plurality of resource blocks that is pre-allocated to the terminal equipment for data transmission with the base station, and using the obtained RSSI to serve as an RSSI of each of the plurality of resource blocks; and
dividing the RSSI of each of the resource blocks by the RSRP of each of the resource blocks to obtain the interference indicator of each of the resource blocks.

12. The radio resource allocation system according to claim 10, wherein the plurality of quality parameters of each of the resource blocks further include a jitter value and a quantity of supportable network slices.

13. The radio resource allocation system according to claim 12, wherein the step of obtaining a plurality of quality parameters of each of the plurality of resource blocks further comprises:
obtaining a jitter value for each of the plurality of resource blocks that is pre-allocated to a terminal equipment for data transmission with the base station, using the obtained jitter value to serve as the jitter value of each of the resource blocks, and obtaining the quantity of the supportable network slices of each of the resources through the base station.

14. The radio resource allocation method according to claim 12, wherein the plurality of priority indices used to allocate the plurality of resource blocks respectively to the plurality of network slices are represented by a following equation:
$${ε}_{k} ( i ) = α \cdot {P}_{r s r p} ( i ) + β \cdot \frac{1}{E R ( i )} + γ \cdot \frac{1}{{P}_{inter} ( i )} + δ \cdot \frac{1}{N ( i )} + θ \cdot \frac{1}{T ( i )} ;$$
where εₖ (i) is the priority index used to allocate an i-th resource block in the plurality of resource blocks to a k-th network slice of the plurality of network slices, i is a positive integer less than or equal to a total number of the plurality of resource blocks, k is a positive integer less than or equal to a total number of the plurality of network slices, Pᵣₛᵣₚ(i) is the RSRP of the i-th resource block, ER(i) is the error rate of the i-th resource block, Pᵢₙₜₑᵣ(i) is the interference indicator of the i-th resource block, N(i) is the quantity of the supportable network slices of the i-th resource block, T(i) is the jitter value of the i-th resource block, and α, β, γ, δ and θ are the weight coefficients corresponding to the RSRP, the error rate, the interference index, the quantity of the supportable network slices and the jitter value, respectively.

15. The radio resource allocation system according to claim 14, wherein the step of generating the plurality of priority orders further comprises:
sorting the priority indices used to allocate the plurality of resource blocks to each of the plurality of network slices from high to low, so as to generate the plurality of priority orders.

16. The radio resource allocation method according to claim 15, wherein, before generating the plurality of priority orders, the processing device is further configured to execute the following steps:
determining whether or not the priority indices used to allocate the plurality of resource blocks to one of the network slices have identical values;
in response to determining that the priority indices used to allocate the plurality of resource blocks to one of the network slices have the identical values, using the resource blocks that are allocated to the one of the network slices and corresponding the identical values to serve as target resource blocks, and calculating the data rates of the target resource blocks, respectively; and
according to the data rates of the target resource blocks, adjusting the priority indices that are used to allocate the target resource blocks to the network slices and have the identical values.
